(19) United States
(12) Patent Application Publication
(10) Pub. No.: US 2024/0420372 A1
(43) Pub. Date: Dec. 19, 2024

(54) METHOD FOR DETERMINING A COLOR OF A TRACKED OBJECT

(71) Applicant: Axis AB, Lund (SE)

(72) Inventors: Jiandan CHEN, Lund (SE); Johan STERNBY, Lund (SE); Joel SJÖBOM, Lund (SE); Ruben BERGENGRIP, Lund (SE); Max JOKI, Lund (SE)

(73) Assignee: Axis AB, Lund (SE)

(21) Appl. No.: 18/653,356

(22) Filed: May 2, 2024

(30) Foreign Application Priority Data
Jun. 14, 2023 (EP) 23179223.5

(51) Int. Cl. G06T 7/90; G06T 7/246

(52) U.S. Cl. CPC G06T 7/90; G06T 7/248; G06T 2207/10016; G06T 2207/20076

(57) ABSTRACT

A method, system and software for determine a color of a tracked object. Using a first video sequence and foreground objects detected therein, a color rendering metric may be determined for each area of a plurality of areas in the scene. Such color rendering metrics may then be used in case a tracked object is determined to have different colors in different images of a second video sequence, such that the colors detected in an area associated with a higher color rendering metric is selected over an area associated with a lower color rendering metric.

### TECHNICAL FIELD

The present invention relates to determining a color of a tracked object in a video sequence depicting a scene, and in particular to determining a color of a tracked object in a video sequence depicting a scene with varying lighting conditions.

### BACKGROUND

Color cast refers to an overall tint of a particular color that pervades an image, usually a result of specific lighting conditions. Uneven color cast, a variant of this phenomenon, refers to different tints appearing in different areas of an image. This can transpire when diverse light sources with disparate color temperatures illuminate different aspects of the scene. For instance, in an outdoor setting, daylight and street lighting may coexist, producing mixed lighting conditions. Daylight could cast a cooler, bluer light on certain parts of the scene, while street lighting might impose a warmer, yellowish light on others. In addition to this, shadows can also introduce localized color casts. The color of light in shadows often differs from the direct light, contributing to an uneven color cast.

An example of an application where uneven color cast is important to handle is in monitoring systems, particularly when an operator examines video sequences to locate objects of a specific color. Manually sifting through multiple video sequences to identify items of interest can be both tedious and time-consuming. To mitigate this issue, automated video analytics tools are generally employed to analyse the video sequences. These tools can detect objects in the sequences and annotate the detected objects with attributes such as object type, size, and velocity. These features can then be utilized by the operator when searching for a specific object of interest, for example in a forensic search application. An important feature when searching for an object in an image or video sequence is the color of the object. However, the apparent color of an object will be influenced by surrounding light sources, such as natural light sources and artificial light sources, which may result in a faulty impression of the color of the object in the image. An example of this is a white car under a yellow streetlight, which may result in that the color of the car in an image capturing that scene is yellow rather than white.

A further problem is that lighting conditions in a scene vary based on many different reasons, such as placement of active artificial light sources, time of day, time of year, weather conditions, buildings, vegetation, etc. This makes it difficult to accurately determine an actual or natural color of an object captured in an image which in turn may negatively influence the possibility to search for an object based on the color of the object.

US 2007/154088 discusses color identification in digital images with the objective to determine the robust perceptual color or true color of an object, defined as the object's color perceived under some standard viewing, lighting and sensing conditions. CN 107 292 933 describes using a neural network for determining color.

Thierry Bouwmans et al: “On the role and the importance of features for background modelling and foreground detection”, Arxiv.org, Cornell University library, 28 Nov. 2016,XP080735023 describes modelling and color variance for the purpose of detection. There is thus a need for improvements in this context.

### SUMMARY

In view of the above, solving, or at least reducing, one or several of the drawbacks discussed above would be beneficial, as set forth in the attached independent patent claims.

According to a first aspect of the present invention, there is provided a computer implemented method for determining a color of a tracked object, comprising the steps of: providing a first video sequence depicting a scene, the first video sequence comprising a plurality of image frames; for each image frame of the plurality of image frames, detecting foreground objects in the image frame; for each area of a plurality of areas in the scene, analyzing the first video sequence and calculating an object color probability vector associated with the area of the scene, wherein each value in the object color probability vector relates to a color from a set of predefined colors and indicates a probability that a foreground object located in the area of the scene has the color; for each area of the plurality of areas of the scene, calculating a measurement of variability of the probabilities indicated by the object color probability vector associated with the area of the scene, and associating the measurement of variability with the area of the scene.

The method further comprises providing a second video sequence depicting the scene; tracking a foreground object in the second video sequence, the tracked foreground object being located in a first area of the plurality of areas in the scene in a first image frame of the second video sequence, and in a second different area of the plurality of areas in the scene in a second image frame of the second video sequence; determining a first set of colors of the tracked foreground object in the first image frame, and determining a second different set of colors of the tracked foreground object in the second image frame; and upon determining that the measurement of variability associated with the first area of the scene is lower than the measurement of variability associated with the second area of the scene, determining that the color(s) of the tracked foreground object is the first set of colors, and otherwise determining that the color(s) of the tracked foreground object is the second set of colors.

An “object color probability vector” is a mathematical representation associated with a specific area of a scene. Each value within this vector corresponds to a color from a predefined set of colors. The predefined set of colors may for example comprise 8 colors, 12 colors, 16 colors, etc. The granularity of the predefined set of colors typically depends on the application. For example, too many shades of blue in the set may result in a difficulty to specify the actual blue color when searching for an object, e.g., in a forensic search application, and thus increase the risk of false negatives in the search. On the other hand, too few colors may result in an increase of false positives since all shades of blue that an object can have may fall under the color “blue”. Each value in the object color probability vector indicates the likelihood or probability that a foreground object located within that specific area of the scene possesses the corresponding color, i.c., indicates an estimated likelihood that a foreground object in the area of the scene will be of the color corresponding to that value. It should be noted that each value in the object color probability vector may directly or indirectly represent the probability. A direct representation may for example comprise a percentage, e.g., 23% probability that an object with the color “light yellow” will occur in the area of the scene. An indirect representation may for example comprise a count of objects with the corresponding color that has been detected in the area of the scene, e.g., 15 objects with the color “dark red” has been detected in the area of the scene. Such indirect representation needs to be compared with the other values in the object color probability vector to determine the actual probability of an object with the color “dark red” occurring in the area of the scene, e.g., 15 out of a total of 73 objects detected in the area of the scene has the color “dark red” resulting in a probability of 20.5%.

The term “measurement of variability” should, in the context of present specification, be interpreted as a statistical term that refers to how spread out a set of data (object color probability vector) is. It indicates the degree of diversity or dissimilarity in the dataset, providing a sense of how much the numbers in the dataset “vary” from the average (or the centre point) and from each other. If all the numbers in the object color probability vector (i.e., the probabilities) are close to each other and the average, the variability is low. If the numbers are widely spread out, the variability is high. For example, the measurement of variability for the object color probability vector comprising the values [0.2, 0.3, 0.3, 0.2] is lower than the measurement of variability for the object color probability vector comprising the values [0.1, 0.7, 0.1, 0.1]. Specifically, in an area of the scene where objects exhibit a wide variety of colors, the measurement of variability is often lower. This is due to the multitude of colors equally contributing to the probability distribution, reflecting an even representation across the color spectrum. The measurement is an aggregate based on multiple objects with differing colors. As a result, when the color variations are vast and balanced, the associated probabilities tend to converge, leading to lower variability since no single color predominantly influences the overall measure.

As described above, an apparent color of an object will be influenced by surrounding light sources, such as natural light sources and artificial light sources. For example, if an area of the scene is illuminated by a yellow light, the apparent color of an object in that area of the scene as captured by an image may shift towards yellow, even though the natural color of the object is not yellow. In another example, an area of the scene is shadowed by a building. The apparent color of an object in that area of the scene as captured by an image may shift towards darker colors (c.g., dark red, dark blue, black, etc.) even though the natural color of the object is not dark. For such areas in the scene, where light sources and/or shadows may skew or influence the apparent color of object towards a particular shade (color cast as described above), the measurement of variability will be larger than for areas in the scene with more natural light. For example, if there is a yellow color cast due to a yellow streetlamp, a white car under the lamp would look yellowish, because the yellow light from the lamp is reflecting off the car. Similarly, a blue car would look more greenish under the yellow light, because the blue of the car combined with the yellow light results in a greenish color. The probability that a foreground object located in the area of the scene (as captured by an image) is determined to have a yellow or green color may thus increase while the probability that a foreground object located in the area of the scene is determined to have a white or blue color may decrease, resulting in an increased measurement of variability for the area of the scene under the yellow street lamp compared to an area of the scene with only natural light.

The inventors have realized that such a measurement of variability may be used to determine a color (or colors) for a tracked object, in the case that different set of colors (one or more colors) are determined for the object while it moves through the scene. The variability is determined during a configuring (training) phase, by detecting foreground objects in a video sequence (or several video sequences) capturing the scene and using the image data of the video sequence to determine colors of objects located in different areas of the scene.

A lower measurement of variability associated with an area of the scene points to that the colors of objects located in that area may be rendered more accurately in an image capturing the scene compared to an area associated with a higher measurement of variability, as discussed above. The measurement of variability may thus be used as a color rendering metric associated with a specific area of the scene. The term “color rendering metric” refers to a quantitative measure of the ability of light source(s) (i.c., the light sources illuminating an area of the scene, possibly influenced by other objects resulting in shadows etc.) to accurately reveal the colors of various objects compared to an ideal or natural light source. A lower measurement of variability results in a higher color rendering metric, and vice versa.

The variability determined during the configuration phase may thus be used for a further video sequence capturing the scene, to decide an “actual” color of an object moving through the scene as described herein. Advantageously, a most likely color (set of colors) for an object may be determined.

In some embodiments, all occurrences of the tracked foreground object in the second video sequence are labelled with the determined color(s). Advantageously, also images showing the foreground object when being in an area of the scene where the apparent color is skewed away from its natural color, as described above, may be flagged when searching for an object of that particular color in the second video sequence.

In some embodiments, each of the first and second set of colors comprises one of: a single color value; a plurality of color values; or a plurality of color values, each color value associated with a probability that the tracked object has the color. For example, the set of colors may be determined using a neural network trained to, based on input pixel data depicting the object, output a plurality of color values, each color value associated with a probability that the tracked object has the color. The plurality of color values is typically limited to the set of predefined colors. In another example, pixel data depicting the object may be used to calculate the average color, e.g., adding up all the red, green, and blue values from the RGB pixel data separately, and then dividing by the number of pixels to get the average red, green, and blue values. The resulting RGB value may then be used as the single color value. In another embodiment, color quantization or clustering, which groups similar colors together, may be used to determine a plurality of color values (the most common colors) for the object.

In case the first and second video sequence is captured by a camera with a same field of view in the scene, an area of the scene corresponds to a same pixel region in the image frames of the first and second video sequence. The granularity of the area of the scene depends on the requirements of and limitations of the application. For example, fewer areas of the scene may result in less computational resources being used for implementing the method. On the other hand, increasing the number of areas in the scene may result in a more accurate end result (of the determined color(s) of the foreground object) since the likelihood of finding an area of the scene with advantageous lighting may increase. In some embodiments, each area of the scene corresponds to a single pixel coordinate in the image frames of the first and second video sequence.

In case the first and second video sequence is captured by a camera with a changing field of view in the scene, the method further comprises the step of: determining a pixel region in an image frame from the first or the second video sequence that corresponds to an area of the scene using camera parameters, the camera parameters comprising one or more of: pan, tilt, roll or zoom. Consequently, the techniques described herein may be used also on video captured by a moving camera.

In some embodiments, the step of detecting foreground objects in the image frame comprises determining a location and an extent of each detected foreground object in the image frame, wherein the location and extent comprises one of: a pixel mask, or a bounding box. The location and extent may be used to map an object to a certain area of the scene. If the bounding box/pixel mask of the object at least partly overlaps more than one area of the scene, the colors of the object may contribute to the object color probability vectors associated with each of these areas.

In some embodiments, the step of analyzing the first video sequence comprises, for each foreground object located in the area of the scene in an image frame of the first video sequence: determining one or more colors of the foreground object from pixel data depicting the foreground object in the image frame; and using the determined one or more colors when calculating the object color probability vector associated with the area of the scene. For example, pixel data depicting the object may be used to calculate the average color, c.g., adding up all the red, green, and blue values from the RGB pixel data separately (or similarly for other color spaces such as HSV, CIE), and then dividing by the number of pixels to get the average red, green, and blue values. The resulting RGB value may then be used as the single color value. In another embodiment, color quantization or clustering techniques, which groups similar colors together, may be used to determine a plurality of color values (the most common colors) for the object. The one or more colors determined for the foreground object may all be part of the set of predefined colors. Color quantization techniques may be used to map a color of the object to one of the predefined colors. The object color probability vector associated with the area of the scene may then be updated using the determined one or more colors of the foreground object, for example by updating an object count for each of the one or more colors, or by recalculating probabilities based on of the one or more colors.

In examples, the step of analyzing the first video sequence comprises, for each foreground object located in the area of the scene in an image frame of the first video sequence: receiving a plurality of color values, each color value associated with a probability that the foreground object has the color in the image frame; and using the plurality of color values and their associated probabilities when calculating the object color probability vector associated with the area of the scene. The plurality color values may be received from a neural network trained to, based on input pixel data depicting the foreground object, output a plurality of color values, each color value associated with a probability that the tracked object has the color. The plurality of color values is typically limited to the set of predefined colors. The object color probability vector associated with the area of the scene may then be updated using the color values and their respective associated probability.

In some examples, wherein the step of calculating an object color probability vector for an area of the plurality of areas in the scene comprises detecting at least a threshold number of foreground objects in the area of the scene. In some embodiments, at least the threshold number of each foreground object class of a plurality of foreground object classes needs to be detected. Consequently, a sufficient number of objects located in an area of the scene may be analysed to determine a representative object color probability vector for the area of the scene. The threshold number depends on the requirements of the application as well as the scene captured by the video sequences. For example, the threshold number may be 50, 100, 130, 210, 450, etc.

In embodiments, the first video sequence is captured during a first time period of a day, wherein the second video sequence is captured during a second time period of a subsequent day, wherein the second time period is entirely encompassed within the first time period. Advantageously, the lighting conditions of the configuration/training phase of the object color probability vectors may sufficiently well conform to the lighting conditions when the object color probability vectors are used. The techniques described herein may advantageously be used for video captured during daylight hours since this increases the possibility that at least some of the areas of the scene is illuminated such that the true color of an object is captured by an image. Consequently, in some embodiments, the first video sequence (and the second video sequence) is captured during daylight hours.

In some examples, the measurement of variability is at least one of: variance, standard deviation, mean absolute deviation, median absolute deviation or coefficient of variations.

According to a second aspect of the invention, the above object is achieved by a non-transitory computer-readable storage medium having stored thereon instructions for implementing the method according to the first aspect when executed on a device having processing capabilities.

According to a third aspect of the invention, the above object is achieved by a system comprising: one or more processors; and one or more non-transitory computer-readable media storing first computer executable instructions that, when executed by the one or more processors, cause the system to perform actions as detailed in the appended claims.

According to a fourth aspect of the invention, the above object is achieved by a system comprising a color matching system and a forensic search application, as detailed in the appended claims.

Advantageously, a forensic search application may then be used for searching for an object, wherein a search request comprising a first color value. The first color value can be compared to the color(s) determined for a tracked foreground object and if it is determined that the first color value matches a color determined for the foreground object using the techniques described herein, a search response may be returned based at least in part on the tracked foreground object. The details of the actual search response may be based on the requirements of the forensic search application. For example, a search response may include the image where the object having a color matching the color value of the search request was found, or a time span of a video stream where the object is detected, or a time stamp where the object is detected, a license plate of the object, a face of the object, etc.

The second, third and fourth aspects may generally have the same features and advantages as the first aspect. It is further noted that the disclosure relates to all possible combinations of features unless explicitly stated otherwise.

### BRIEF DESCRIPTION OF THE DRAWINGS

FIG. 1 shows a scene in which light sources and other objects may result in an uneven color cast in images capturing the scene;

FIG. 2 shows a system for calculation of measurements of variability for areas of the scene in FIG. 1, according to embodiments;

FIG. 3 shows a system for using the measurements of variability from FIG. 2 to determine color(s) of a tracked foreground object, according to embodiments;

FIG. 4 shows a system comprising a color matching system according to FIG. 2-3 and a forensic search application, according to embodiments; and

FIG. 5 shows a flow chart of a method for determining a color of a tracked object, according to embodiments.

### DETAILED DESCRIPTION

A color of an object in an image may be determined by the material and surface properties of the object, which determine the amount of light absorbed and reflected by the object and therefore its perceived color. The color of the object in the image may further be influenced by the camera settings (white balance, color profile, etc.) and image post processing. These properties may typically be controllable by the owner of the camera. Properties that may be difficult to control are light sources and lighting conditions when capturing the image or video, in particular in a monitoring situation where the camera is continuously capturing a scene. Light sources and lighting conditions may have a big influence on the detected (apparent, perceived, etc.) color of an object in the image of a scene, which in turn means that the color may be perceived differently depending on time of day, time of year, weather conditions, etc., as well as depending on where in the scene an object is located when capturing the image. This may cause problems when searching for an object, e.g., in a forensic search application, based on a color of the object, or in other applications where it is important to know the color of an object.

The present disclosure aims to provide methods, systems, and softwares for determining a color of a tracked object in a video sequence of a scene, when lighting in the scene is uneven. Uneven lighting may, as described herein, cause uneven color cast in an image depicting the scene, resulting in different parts of the image having different tints.

FIG. 1 shows a scenario with a scene 100 comprising uneven lighting. The scene 100 includes a road for vehicles 108. The scene 100 thus comprises objects 108 moving through the scene 100. The scene 100 further comprises both natural lighting from the sun 102 and the sky, as well as artificial lighting from a streetlamp 106. The scene also includes a tree 104, which casts a shadow over a portion of the scene 100.

The depicted scene 100 can thus be divided into at least three areas 102a-c, each distinguished by unique lighting conditions. The first area 102a is shaded by the tree. The second area 102b is lit by the streetlamp 106. Finally, the third area 102c is exposed to direct sunlight from both the sun 102 and the diffused light from the sky.

It should be noted that the scene depicted in FIG. 1 is simplified for ease of description and that in reality, a scene typically comprises more objects and/or light sources which influence the lighting conditions of different areas of the scene.

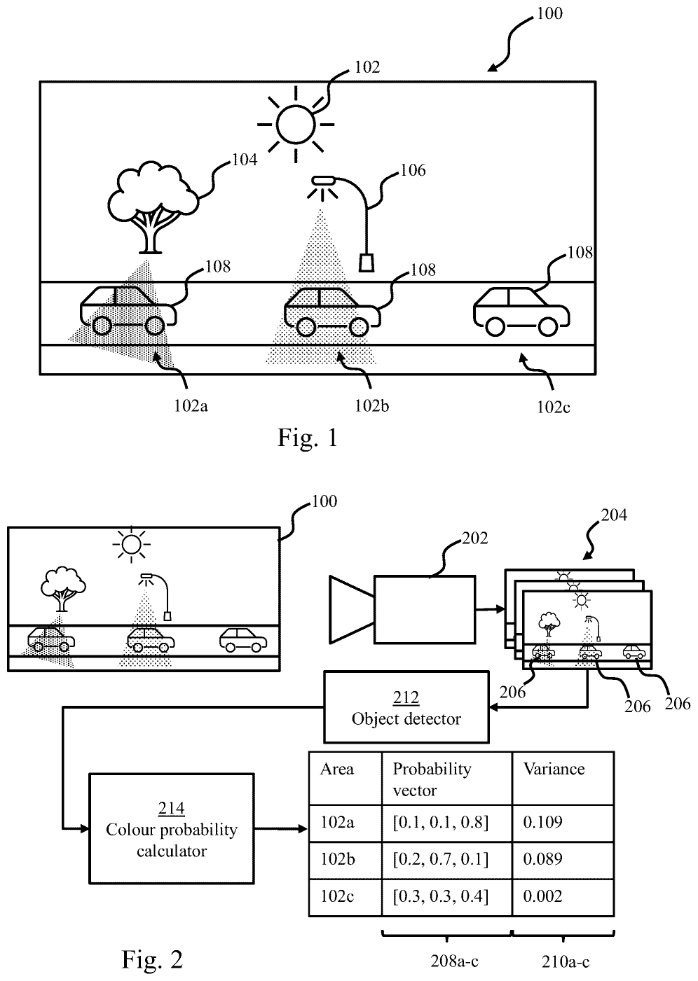

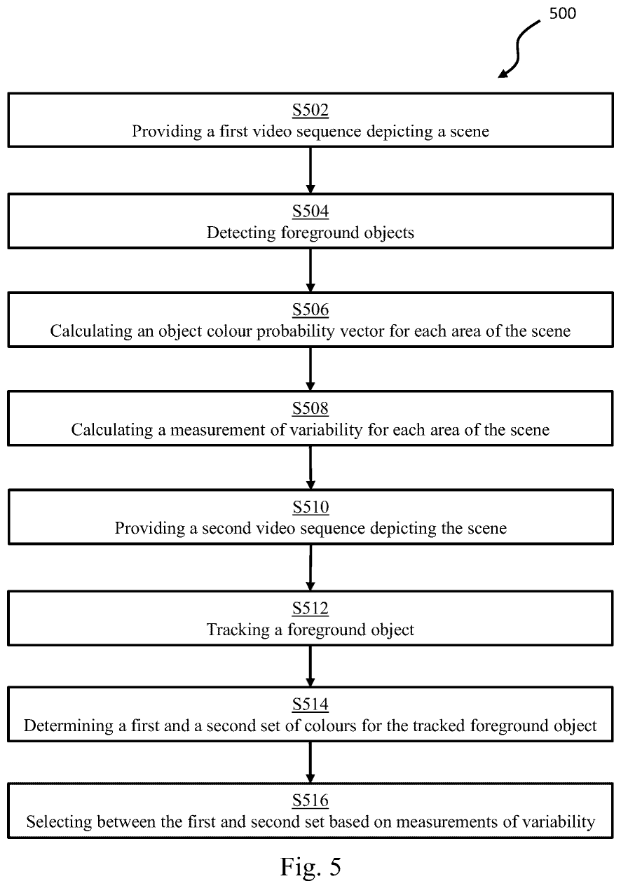

The vehicles 108 moving on the road may be utilized to determine which area of the scene 100 that results in the most accurate colors of objects (located in the area), when depicted by an image/video stream capturing the scene 100. The process of calculating a color rendering metric for an area of a scene will now be explained in conjunction with FIG. 2 and FIG. 5.

FIG. 5 shows a flow chart of a method 500 of determining a color of a tracked object. The method comprises a training/configuration phase S502-S508 and an implementation phase S510-S516. The training phase will now be described in conjunction with FIG. 2.

FIG. 2 shows a camera 202 capturing the scene from FIG. 1, and thus providing S502 a video sequence 204 depicting the scene 100.

The image frames of the video sequence 204 cach comprises background objects (a background) and foreground objects 206. The foreground objects 206 are, in this simplified example, the vehicles 108 moving in the scene.

An object detector 212 is used to, for each image frame of the plurality of image frames of the video sequence 204, detect S504 the foreground objects 206 in the image frame. Any suitable type of object detector may be used, both neural networks-based techniques and non-neural network-based techniques. Neural network-based techniques include using convolutional neural networks using models such as YOLO (You Only Look Once), SSD (Single Shot MultiBox Detector), DETR (End-to-end detection with transformers), and Faster R-CNN (Region-based Convolutional Neural Networks). Other neural network-based techniques include LSTM (Long Short Term Memory) and GRU (Gated Recurrent Unit) networks. Non neural network-based techniques include Histogram of Oriented Gradients (HOG), Scale-Invariant Feature Transform (SIFT) and Speeded Up Robust Features (SURF).

The detected foreground objects 206 are sent to a Color probability calculator 214. The Color probability calculator 214 may be configured to divide the scene into areas of the scene, or to receive data indicating the areas of the scene.

In the case of a fixed camera 202 capturing the scene 100, cach area of the scene corresponds to a same pixel region in the image frames of the video sequence 204. For example, each area of the scene may correspond to a 10*10 pixel region of the image frames of the video sequence, or a 20*20 pixel region, or a 30*20 pixel region or any suitable sized pixel region. In some embodiments, each area of the scene corresponds to a single pixel coordinate in the image frames of the video sequence 204. The areas of the scene may in some embodiments be determined based on an analysis of the lighting conditions of the scene. In other embodiments, the areas of the scene may be determined based on a semantic segmentation of the background of the scene.

In case (not shown in FIG. 2), the video sequence is captured by a camera with a changing field of view in the scene, a pixel region in an image frame from the video sequence that corresponds to an area of the scene is determined using camera parameters, the camera parameters comprising one or more of: pan, tilt, roll or zoom.

In the simplified example of FIG. 2, the scene is captured by a fixed camera and is divided into three areas of the scene 102a, 102b, 102c, according to the above description of FIG. 1.

For each area of the scene, the Color probability calculator may calculate S506 an object color probability vector 208a-c associated with the area of the scene 102a-c. Each value in the object color probability vector 208a-c relates to a color from a set of predefined colors and indicates a probability that a foreground object 206 located in the area of the scene 102a-c has the color.

The predefined colors may be configured based on the requirements of the system described herein. For example, the predefined colors may comprise 10-25 different colors, or 5-10 colors. An increase in the number of colors may require a prolonged training phase of the system and techniques described herein. This is because a threshold number of foreground objects detected in a particular area of the scene in order to calculate a representative object color probability vector 208a-c may correlate with the number of predefined colors. On the other hand, the accuracy of determining a most suitable area of the scene for color determination (as will be described further below) may increase if the number of predefined colors increase. Accordingly, in some embodiments, calculating an object color probability vector 208a-c for an area of the plurality of areas 102a-c in the scene 100 comprises detecting at least a threshold number of foreground objects 206 in the area of the scene. The threshold number may depend on the number of predefined colors, the number of moving objects 108 that typically is located in the scene 100 per time interval, the variability of the colors of such objects 108, etc.

The determining of the color(s) of the foreground objects 206 in the video sequence may be implemented with any suitable color determining algorithm. In some embodiments, the step of analyzing the first video sequence comprises, for each foreground object located in the area of the scene in an image frame of the first video sequence: determining one or more colors of the foreground object from pixel data of the foreground object in the image frame; and using the determined one or more colors when calculating the object color probability vector associated with the area of the scene. The pixel data to use for a particular foreground object 206 may be determined by the object detector 212, which may determine a location and an extent of each detected foreground object 206 in each the image frame, wherein the location and extent comprises one of: a pixel mask, or a bounding box. Such pixel data may thus be analysed to determine one or more colors of the pixel data. For example, a histogram of colors may be determined and mapped to the predetermined colors. The predetermined color that has most pixels in the pixel data with the same color or similar color may be chosen as the color of the object. In some cases, more than one color is determined for an object, for example the most common colors in the pixel data. Mapping of the colors of the pixel data to the predetermined colors may involve comparing a color of the pixel data with each of the colors among the predetermined colors to choose the “closest” one. The definition of closest may vary based on the color space, but generally, calculating a Euclidian distance between the color to map and each of the predetermined colors may suffice. If enough pixels (e.g., above a certain percentage threshold) are similar enough (e.g., distance below a distance threshold), the object may be determined to have the relevant predetermined color. The determined colors for an object located in an area of the scene may get a “tick” (an increase of the valuc/count) in the object color probability vector (associated with the area of the scene in which the object is located) for that color. After the training phase, an object color probability vector for a certain area of the scene may look like this (5 predetermined colors, black, white, blue, red, green): [46, 120, 66, 40, 23], which may be converted to probabilities: [0.16, 0.41, 0.22, 0,13,0.08]. For another area of the scene, the numbers may be different based on the illumination conditions as described above.

In other embodiments, a neural network may be used to determine a color of an object. For example, the neural network may be trained to determine a probability of an object having a certain color. The training may involve using training data, each training data comprising a set of pixels, which are labelled with one or more of the predetermined colors. The neural network may use this training data to learn how to identify the correct colors (among the predetermined colors) for a particular set of pixels. The output from using the neural network may be a plurality of color values, cach color value associated with a probability that the foreground object has the color in the image frame. For example, an output for a dark blue object may result in the following probabilities (for 5 predetermined colors, black, white, blue, red, green): [0.30, 0.01, 0.6, 0.05,0.04]. Such vector may be used to add on to, or recalculate, the values of the object probability vector 208a-c. For example, the object probability vector 208a-c may be normalized to always have a total value of one (100%) of the sum all the individual values in the vector. In some embodiments, the colors among the predetermined colors that have a probability in the output from the neural network above a threshold probability for a certain input object may get a “tick” (an increase of the value/count) in the object color probability vector for that color/colors, as described above.

In some embodiments, an object is located in more than one area of the scene at the same time, for example when the size of the object is greater than the size of areas of the scene. In such cases, a determined color(s) of the object in an image frame of the video sequence may influence more than one object probability vector. For example, as mentioned above, the step of detecting foreground objects in the image frame comprises determining a location and an extent of each detected foreground object in the image frame, wherein the location and extent comprises one of: a pixel mask, or a bounding box. In such examples, all areas of the scene at least partly overlapped by the pixel mask/bounding box of an object detected in an image frame may be influenced by the colors determined for that object.

In the example of FIG. 2, the number of predetermined colors is three (3). The object probability vector 208a for the area 102a (which is shadowed by a tree 104 in the scene 100) is determined to be [0.1, 0.1, 0.8]. The object probability vector 208b for the area 102b (which is illuminated by a streetlight 108 in the scene 100) is determined to be [0.2, 0.7, 0.1]. The object probability vector 208c for the area 102c (which is exposed to direct sunlight from both the sun 102 and the diffused light from the sky in the scene 100) is determined to be [0.3, 0.3, 0.4].

The color probability calculator 214 is further configured to calculate S508 a measurement of variability 210a-c of the probabilities indicated by the object color probability vector associated with the area of the scene. As described above, the measurement of variability may be used as a color rendering metric, e.g., a quantitative measure of the ability of light source(s) in an area of the scene (i.e., the light sources illuminating an area of the scene, possibly influenced by other objects resulting in shadows etc.) to accurately reveal the colors of various objects compared to an ideal or natural light source.

In FIG. 2, the measurement of variability 210a-c is calculated using the variance of the respective object probability vectors 208a-c. In other embodiments, other measurements may be used such as standard deviation, mean absolute deviation, median absolute deviation or coefficient of variations. In any event, a measurement of variability of an area of the scene that is lower (less variability among the probabilities of objects having the respective predetermined colors) indicates an area of the scene with a suitable illumination for determining a “true” color of an object, since a low variability indicates that image data capturing the scene at that area of the scene is not tinted in way that skews the color distribution of the objects captured at that area of the scene.

In FIG. 2, the variance 210a of the shadowed area 102a is 0.109, the variance 210b of the streetlight illuminated area 102b is 0.089 while the variance 210c of the area of the scene 102cilluminated with natural light is 0.002. The third area of the scene 102c may thus be the most suitable (among the three areas 102a-c) for determining a “true” color of an object.

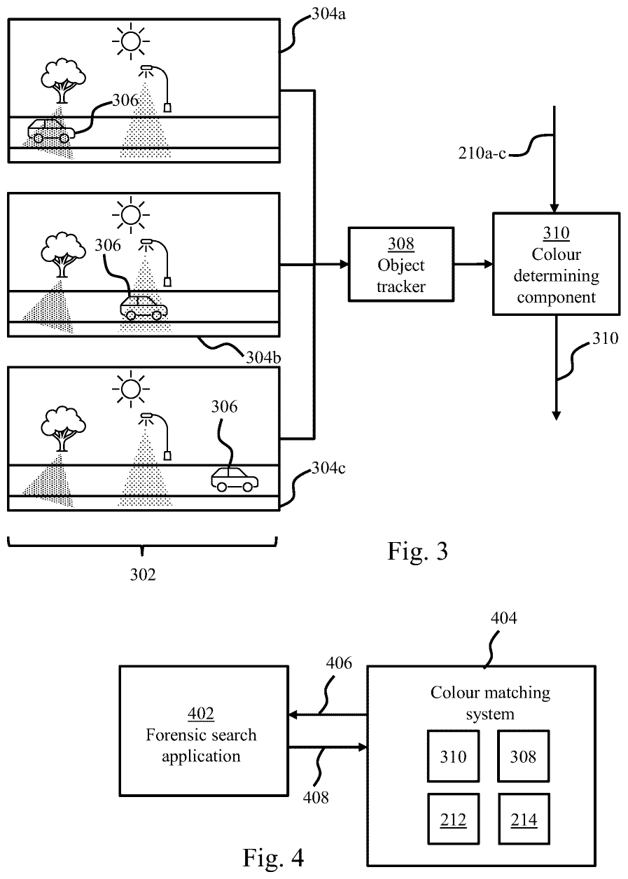

FIG. 3 shows how the metrics calculated in FIG. 2 is used for a second video sequence 302 depicting the scene 100 from FIG. 1. The usage of the metrics will now be described in conjunction with the implementation phase S510-S516 of the method 500 shown in FIG. 5.

The second video sequence 302 depicting the scene 100 is provided S510. In FIG. 3, the second video sequence 302 comprises three image frames 304a-c. The image frames 304a-c depict a foreground object 306 moving in the scene. The image frames 304a-c is inputted to an object tracker 308 for tracking the detected foreground objects. There are several techniques used for tracking objects in video sequences, ranging from classic computer vision techniques to modern deep learning approaches, for example using Optical Flow, Kalman filtering, Particle filters, Correlation filters, or Deep SORT (Simple Online and Realtime Tracking with a Deep Association Metric) algorithm, which uses a CNN to extract features and a Kalman filter to predict motion, etc.

The foreground object 306 may be tracked S512 in the second video sequence 302 by the object tracker 308. The tracked foreground object 306 is located in a first area 102a of the plurality of areas 102a-c in the scene in the first image frame 304a of the second video sequence, in a second different area 102b of the plurality of areas in the scene in the second image frame 304b, and in third different area 102c of the plurality of areas in scene in the third image frame 304c.

The system of FIG. 3 further comprises a Color determining component 310 which may be used to determine color(s) of the tracked object 306. The measurements of variability 210a-c for each area 102a-c of the scene calculated in FIG. 2 may be input to the Color determining component 310. The Color determining component 310 may be configured to determine S512 a first set of colors of the tracked foreground object 306 in the first image frame 304a-c (when located in the first area of the scene 102a), a second different set of colors of the tracked foreground object 306 in the second image frame 304b (when located in the second area of the scene 102b), and a third different set of colors of the tracked foreground object 306 in the third image frame 304c (when located in the third area of the scene 102c). The different sets of colors may be determined as described above. As such, the sets of colors may comprise one of: a single color value; a plurality of color values; or a plurality of color values, each color value associated with a probability that the tracked object has the color.

Using the measurements of variability 210a-c, the Color determining component 310 may select S516 among the sets of colors. More specifically, the Color determining component 310 may select the set of colors that is determined for the object when it is in the area of the scene with the comparably lower measurement of variability. The Color determining component 310 may thus determine that the color(s) 310 of the tracked object 306 is the set of colors that is determined for the object 306 when it is in the area of the scene with the comparably lower measurement of variability. In this case, the color(s) 310 of the tracked object 306 is determined to be the set of colors determined for the object 306 in the third image frame 304c, i.e., the third set of colors.

In some embodiments, the Color determining component 310 may be configured to label all occurrences of the tracked foreground object 306 in the second video sequence 302 with the determined color(s) 310. This may be particularly advantageous in a system comprising a Color matching system 404 (as described in conjunction with FIGS. 2-3 above) and a Forensic search application 402. The Color matching system 404 may comprise the components 212, 214, 308, 310 discussed above and may be configured to implement the functionality of determining color(s) of a tracked object in a second video sequence (as described above in conjunction with FIG. 3) based on measurements of variability of areas in the scene as determined using detected objects in a first video sequence (as described above in conjunction with FIG. 2). The Color matching system 404 may further be configured to receiving a search request 408 comprising a first color value, determining that the first color value matches a color determined for the foreground object; and returning a search response 406 based at least in part on the foreground object.

The Forensic search application 402 may be configured to provide the search request 408 comprising the first color value to the Color matching system 404, receive a search response 406 from the Color matching system 404; and display data from the search response to a user.

The Color matching system 404 may in examples be implemented in a single device such as a camera. In other examples, some or all of the different components (modules, units, etc.,) 212, 214, 308, 310 may be implemented in a server or in the cloud. Generally, the device (camera, server, etc.,) implementing the components 212, 214, 308, 310 may comprise circuitry which is configured to implement the components 212, 214, 308, 310 and, more specifically, their functionality. The described features in the Color matching system 404 and the Forensic search application 402 can be implemented advantageously in one or more computer programs that are executable on a programmable system including at least one programmable processor coupled to receive data and instructions from, and to transmit data and instructions to, a data storage system, at least one input device such as a camera, and in some cases at least one output device such as a display. Suitable processors for the execution of a program of instructions include, by way of example, both general and special purpose microprocessors, and the sole processor or one of multiple processors or cores, of any kind of computer. The processors can be supplemented by, or incorporated in, ASICs (application-specific integrated circuits).

The above embodiments are to be understood as illustrative examples of the invention. Further embodiments of the invention are envisaged. For example, the training phase may relate to a particular time span of day, a particular time of the year, a particular weather situation etc. The measurement of variabilities determined for different time periods/weather, etc., may be stored and implemented when a similar time period/weather conditions occur, e.g., in the Color determining component 310 of FIG. 3. In some embodiments, the measurement of variabilities of areas of the scene are reset or recalibrated on a regular basis.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer implemented method for determining a color of a tracked object, comprising the steps of:
providing a first video sequence depicting a scene, the first video sequence comprising a plurality of image frames;
for each image frame, detecting foreground objects;
for each area of a plurality of areas in the scene, analyzing the first video sequence and calculating an object color probability vector associated with the area of the scene, wherein each value in the object color probability vector relates to a color from a set of predefined colors and indicates a probability that a foreground object located in the area of the scene has the color;
for each area, calculating a measurement of variability of the probabilities indicated by the object color probability vector associated with the area of the scene, and associating the measurement of variability with the area of the scene;
providing a second video sequence depicting the scene;
tracking a foreground object in the second video sequence, the tracked foreground object being located in a first area of the plurality of areas in the scene in a first image frame of the second video sequence, and in a second different area of the plurality of areas in the scene in a second image frame of the second video sequence;
determining a first set of colors of the tracked foreground object in the first image frame, and determining a second different set of colors of the tracked foreground object in the second image frame; and
upon determining that the measurement of variability associated with the first area of the scene is lower than the measurement of variability associated with the second area of the scene, determining that the color(s) of the tracked foreground object is the first set of colors, and otherwise determining that the color(s) of the tracked foreground object is the second set of colors,
wherein the first and second video sequence is captured by a camera with a same field of view in the scene, wherein an area of the scene corresponds to a same pixel region in the image frames of the first and second video sequence,
or
wherein the first and second video sequence is captured by a camera with a changing field of view in the scene, wherein the method further comprises the step of:
determining a pixel region in an image frame from the first or the second video sequence that corresponds to an area of the scene using camera parameters, the camera parameters comprising one or more of: pan, tilt, roll or zoom.

2. The method of claim 1, further comprising the steps of:
labelling all occurrences of the tracked foreground object in the second video sequence with the determined color(s).

3. The method of claim 1, wherein each of the first and second set of colors comprises one of:
a single color value;
a plurality of color values; or
a plurality of color values, each color value associated with a probability that the tracked object has the color.

4. The method of claim 1, wherein each area of the scene corresponds to a single pixel coordinate in the image frames of the first and second video sequence.

5. The method of claim 1, wherein the step of detecting foreground objects in the image frame comprises:
determining a location and an extent of each detected foreground object in the image frame, wherein the location and extent comprises one of:
a pixel mask, or a bounding box.

6. The method of claim 1, wherein the step of analyzing the first video sequence comprises, for each foreground object located in the area of the scene in an image frame of the first video sequence:
determining one or more colors of the foreground object from pixel data depicting the foreground object in the image frame; and
using the determined one or more colors when calculating the object color probability vector associated with the area of the scene.

7. The method of claim 1, wherein the step of analyzing the first video sequence comprises, for each foreground object located in the area of the scene in an image frame of the first video sequence:
receiving a plurality of color values, each color value associated with a probability that the foreground object has the color in the image frame; and
using the plurality of color values and their associated probabilities when calculating the object color probability vector associated with the area of the scene.

8. The method of claim 1, wherein the step of calculating an object color probability vector for an area of the plurality of areas in the scene comprises detecting at least a threshold number of foreground objects in the area of the scene.

9. The method of claim 1, wherein the first video sequence is captured during a first time period of a day, wherein the second video sequence is captured during a second time period of a subsequent day, wherein the second time period is entirely encompassed within the first time period.

10. The method of claim 9, wherein the measurement of variability is at least one of:
variance, standard deviation, mean absolute deviation, median absolute deviation or coefficient of variations.

11. A system comprising:
one or more processors; and
one or more non-transitory computer-readable media storing first computer executable instructions that, when executed by the one or more processors, cause the system to perform actions comprising:
providing a first video sequence depicting a scene, the first video sequence comprising a plurality of image frames;
for each image frame, detecting foreground objects in the image frame;
for each area, analyzing the first video sequence and calculating an object color probability vector associated with the area of the scene, wherein each value in the object color probability vector relates to a color from a set of predefined colors and indicates a probability that a foreground object located in the area of the scene has the color;
for each area, calculating a measurement of variability of the probabilities indicated by the object color probability vector associated with the area of the scene, and associating the measurement of variability with the area of the scene;
providing a second video sequence depicting the scene;
tracking a foreground object in the second video sequence, the tracked foreground object being located in a first area of the plurality of areas in the scene in a first image frame of the second video sequence, and in a second different area of the plurality of areas in the scene in second image frame of the second video sequence;
determining a first set of colors of the tracked foreground object in the first image frame, and determining a second different set of colors of the tracked foreground object in the second image frame;
upon determining that the measurement of variability associated with the first area of the scene is lower than the measurement of variability associated with the second area of the scene, determining that the color(s) of the tracked foreground object is the first set of colors, and otherwise determining that the color(s) of the tracked foreground object is the second set of colors,
wherein the first and second video sequence is captured by a camera with a same field of view in the scene, wherein an area of the scene corresponds to a same pixel region in the image frames of the first and second video sequence,
or
wherein the first and second video sequence is captured by a camera with a changing field of view in the scene, and wherein a pixel region in an image frame from the first or the second video sequence that corresponds to an area of the scene is determined using camera parameters, the camera parameters comprising one or more of: pan, tilt, roll or zoom.

12. A system comprising a color matching system and a forensic search application, wherein the color matching system comprises:
one or more processors; and
one or more non-transitory computer-readable media storing first computer executable instructions that, when executed by the one or more processors, cause the system to perform actions comprising:
providing a first video sequence depicting a scene, the first video sequence comprising a plurality of image frames;
for each image frame of the plurality of image frames, detecting foreground objects in the image frame;
for each area, analyzing the first video sequence and calculating an object color probability vector associated with the area of the scene, wherein each value in the object color probability vector relates to a color from a set of predefined colors and indicates a probability that a foreground object located in the area of the scene has the color;
for each area, calculating a measurement of variability of the probabilities indicated by the object color probability vector associated with the area of the scene, an associating the measurement of variability with the area of the scene;
providing a second video sequence depicting the scene;
tracking a foreground object in the second video sequence, the tracked foreground object being located in a first area of the plurality of areas in the scene in a first image frame of the second video sequence, and in a second different area of the plurality of areas in the scene in second image frame of the second video sequence;
determining a first set of colors of the tracked foreground object in the first image frame, and determining a second different set of colors of the tracked foreground object in the second image frame;
upon determining that the measurement of variability associated with the first area of the scene is lower than the measurement of variability associated with the second area of the scene, determining that the color(s) of the tracked foreground object is the first set of colors, and otherwise determining that the color(s) of the tracked foreground object is the second set of colors;
receiving a search request comprising a first color value;
determining that the first color value matches a color determined for the foreground object; and
returning a search response based at least in part on the foreground object;
wherein the forensic search application comprises:
one or more processors; and
one or more non-transitory computer-readable media storing second computer executable instructions that, when executed by the one or more processors, cause the forensic search application to perform actions comprising:
providing the search request comprising the first color value to the color matching system;
receiving a search response from the color matching system; and
displaying data from the search response to a user,
wherein the first and second video sequence is captured by a camera with a same field of view in the scene, wherein an area of the scene corresponds to a same pixel region in the image frames of the first and second video sequence,
or
wherein the first and second video sequence is captured by a camera with a changing field of view in the scene, and wherein a pixel region in an image frame from the first or the second video sequence that corresponds to an area of the scene is determined using camera parameters,
the camera parameters comprising one or more of: pan, tilt, roll or zoom.
